(19) United States
(12) Patent Application Publication
(10) Pub. No.: US 2003/0136355 A1
(43) Pub. Date: Jul. 24, 2003

(54) On-board system for feeding fuel additive in a motor vehicle

(75) Inventors: Christophe Gouzou, Chalongs en Champagne (FR); Daniel Brunel, Chalons en Champagne (FR); Jean Filjak, Epinay Sur Seine (FR)

Correspondence Address: FOLEY AND LARDNER, SUITE 500, 3000 K STREET NW, WASHINGTON, DC, 20007, US

(73) Assignee: Marwal Systems

(21) Appl. No.: 10/322,748

(22) Filed: Dec. 19, 2002

(30) Foreign Application Priority Data
Dec. 20, 2001 (FR) 0116544

(51) Int. Cl. F02M 25/00

(52) U.S. Cl. 123/1 A; 123/198 A

(57) ABSTRACT

The invention provides a system for feeding fuel additive on board a motor vehicle, the system comprising an additive tank and a metering pump suitable for sucking in a controlled quantity of additive from said tank, under the control of control means in order to deliver said quantity into the fuel of said vehicle. The system is remarkable in that said metering pump is integrated in a fuel-drawing module placed inside a fuel tank of the vehicle. This saves space. The invention is applicable to the automotive industry.

The invention relates to an on-board system for feeding fuel additive in a motor vehicle.

### BACKGROUND OF THE INVENTION

The exhaust gas from a vehicle, in particular a diesel-engined vehicle, contains a certain amount of pollution, including particles of soot. Recent anti-pollution standards that apply to this type of engine require that these particles of soot should be eliminated almost completely from exhaust gas. Such elimination is generally performed by means of a particle filter which tends to clog up progressively as the engine is in operation because of the presence of said particles. In order to clean the filter it is necessary to burn the soot.

For this purpose, various additives such as organo-metallic compounds are added to fuel to act as combustion catalysts for these particles of soot.

In general, the additives are mixed with the fuel during the industrial process of producing the fuel in an oil refinery.

More recently, proposals have been made to provide a motor vehicle not only with a fuel tank but also with a distinct additive tank and with various systems enabling a measured quantity of the additive to be introduced into the fuel tank. Such systems serve to control the quantity of additive that is added and to adapt it as a function of the load on the engine and the temperature of the exhaust gas.

Document FR 2 718 795 in the name of the Applicant discloses a motor vehicle fuel feed system having means for introducing additive into the fuel. The installation described in that document comprises firstly a fuel tank provided in conventional manner with a suction module designed to direct said fuel to its site of use, and secondly with an additive tank provided internally with a suction module and connected via an introduction duct to an injector. The injector is mounted in the top wall of the fuel tank and serves to inject the additive directly into the tank. In addition, excess additive directed to the injector is recovered in a return duct provided with a pressure regulator.

Document EP-0 488 831 describes an installation having firstly a pump for injecting fuel into the cylinders of an engine and connected to a fuel tank via a suction pipe, and secondly an additive injector connected to an additive tank and to an electronic control unit. The injector enables additive to be injected directly into said suction pipe, as a function of the load on the engine.

Nevertheless, the need to have an injector, an electrical power supply for the injector, and sometimes also a return duct for the additive, makes the additive introduction system complex. Furthermore, increasing the number of parts increases the risk of malfunction.

In order to solve that problem, systems are known in the prior art that do not make use of an injector.

Thus, document U.S. Pat. No. 4,621,593 describes an installation comprising an additive tank connected to a fuel tank by a pipe having an electric pump mounted therein. The electric pump enables a measured quantity of additive to be introduced directly into the fuel tank. It is actuated by a control unit servo-controlled to a fuel gauge of the fuel tank. Document DE 3 626 419 describes an installation that is similar except that the pump delivers the additive to a feed pipe of the fuel tank. Finally, in document EP 0 269 228, the pump delivers the additive into the fuel return pipe enabling excess fuel to be brought back from the engine to the fuel tank.

Those prior art systems require sufficient room to be available to receive the pump for metering out the additive. The solution which consists in putting that pump inside the additive tank can sometimes be problematic because of the shape of said tank and the size of the pump, or because of the chemically aggressive nature of the additives with respect to the components making up the pump or its electrical connection means. Finally, the nature of the material used for making the additive tank is sometimes not suitable for enabling a baseplate supporting the metering pump to be connected by heat sealing.

### OBJECTS AND SUMMARY OF THE INVENTION

An object of the invention is to solve the above-mentioned drawbacks.

To this end, the invention provides a system for feeding fuel additive on board a motor vehicle, the system comprising an additive tank and a metering pump suitable for sucking in a controlled quantity of additive from said tank, under the control of control means in order to deliver said quantity into the fuel of said vehicle.

The system is remarkable in that said metering pump is integrated in a fuel-drawing module placed inside a fuel tank of the vehicle.

According to other characteristics of the invention that are advantageous but not limiting:

the metering pump is mounted removably inside the drawing module;

the metering pump is mounted inside the drawing module in such a manner as to be suspended therein;

the metering pump delivers the additive to the inside of the reserve bowl of the fuel-drawing module;

the metering pump delivers the additive into a return duct returning excess fuel that is not used by the engine to the fuel tank;

the metering pump delivers the additive directly into the inside of the fuel tank;

the outlet from the metering pump is provided with an offset tube for delivering the additive to the inside of the fuel tank at a distance from the drawing module;

the outlet from the metering pump is provided with a nozzle for propelling the additive inside the fuel tank away from the drawing module;

the additive tank is located above the metering pump; and

the outlet orifice from the additive tank is situated in the bottom of the tank and is provided with an anti-leakage valve.

### BRIEF DESCRIPTION OF THE DRAWINGS

Other characteristics and advantages of the invention appear on reading the following description of a preferred embodiment of the invention. The description is made with reference to the accompanying drawings, in which:

FIG. 1 is a diagrammatic view of the general architecture of an on-board system for feeding fuel additive in accordance with the present invention; and

FIGS. 2 and 3 are diagrammatic views showing portions of FIG. 1 to show two variants of a second embodiment of the feed system of the invention.

### MORE DETAILED DESCRIPTION

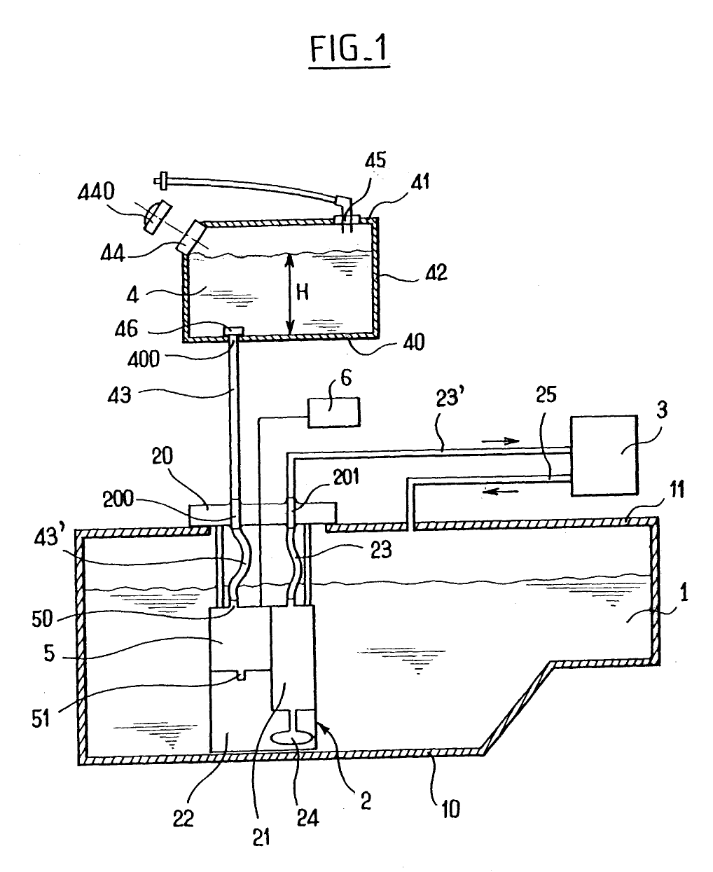

In FIG. 1, there can be seen under overall reference 1, a fuel tank containing a fuel-drawing module 2 (or a combined fuel-drawing and fuel-gauge module). This module is adapted to direct fuel to its site of use, which generally speaking is the engine 3.

Finally, an additive tank is also provided, said tank being given reference 4 and feeding a metering pump 5 that enables the additive to be introduced into the fuel. This metering pump is controlled by control means 6.

These various elements are described below in greater detail.

The fuel tank 1 has a bottom wall 10 and a top wall 11.

The drawing module 2 has a baseplate 20 enabling said module to be fixed to one of the walls of the fuel tank 1, generally its top wall 11. The baseplate 20 has two tubes or pipettes 200, 201 for fixing hoses, as described below.

The drawing module 2 also comprises suction means, e.g. constituted by an electrically controlled pump 21, that is designed to draw fuel from inside a reserve bowl 22 and to direct it towards the engine 3 via a feed duct. The feed duct has two segments 23 and 23′ respectively connecting the outlet of the pump 21 to the inside end of the tube 201, and connecting the outside end of the tube 201 to the engine 3.

The suction end of the pump 21 is generally provided with a filter or strainer 24 placed inside the reserve bowl 22. A fine filter is generally also provided upstream or downstream from the pump 21.

Excess fuel not used by the engine 3 is returned either to the fuel tank 1 or to the reserve bowl 22 via a return duct 25.

The drawing module 2 may also have fuel-gauging means (not shown in FIG. 1) comprising in general manner a float assembly designed to follow the level of the fuel inside the tank 1. The float is associated with a slider guided to move over a resistive track in order to generate output information representative of the level and/or the volume of fuel inside the fuel tank 1.

These gauging means and the drawing module can be implemented in numerous ways known to the person skilled in the art and they are not described in greater detail herein.

The additive tank 4 has a bottom wall 40, a top wall 41, and a side wall 42. It is preferably provided with gauging means suitable for indicating the level of additive in said tank, or at least a minimum level sensor, e.g. based on a thermistor. The additive tank 4 feeds the metering pump 5. For this purpose, a first orifice referred to as an “outlet” orifice 400 is provided through the bottom 40 of the additive tank. It is connected by a first segment of duct 43 to the tube 200, and then the inside end of the tube 200 is connected via a second segment of duct 43′ to the inlet 50 of the pump 5.

The additive tank 4 also has a second orifice 44 constituting a venting and degassing orifice suitable for being closed by a plug 440, and a third orifice 45 for filling the tank 4 and for connecting it to ambient air.

The second orifice 44 is of inside diameter that is sufficient to enable the additive tank to be emptied without having to remove it. Emptying enables old additive to be removed. In practice, its diameter is greater than 10 millimeters (mm). This orifice 44 is provided in the top portion of the tank 4, i.e. in its top wall 41, or as shown in FIG. 1, at the join between the top wall 41 and the side wall 42. The position of this orifice 44 enables the tank to be emptied while the vehicle is in normal use and in the event of leakage via the plug 440.

Finally, the emptying orifice 44 is situated at a height H up the side of the tank, or if it is provided through the top wall 41 it is fitted with a dip tube extending down to the height H, thus making it possible to guarantee that the level of additive does not exceed the level H when the tank 4 is being filled so as to ensure that a certain amount of expansion volume remains in the tank.

This second orifice 44 enables an emptying tube to be inserted into the tank 4. When this orifice is not directly accessible, it may be fitted with a guide pipe enabling said emptying tube to be inserted therein.

The orifice 44 also enables the tank 4 to be degassed during a filling operation, with the advantage that the large diameter (greater than 10 mm) of the orifice can also evacuate any foam that might form during very fast filling. Such filling is performed via the orifice 45 fitted with a pipe 450.

In normal use of the vehicle, the degassing pipe 45 can be left free, or it can be connected to a valve, or to some other member of the vehicle, enabling fuel vapor to be recovered.

The additive tank 4 can thus be emptied or filled with additive without exceeding the level H and without itself being removed.

Finally, and preferably, the outlet orifice 400 is provided with an anti-leakage valve 46 having the function of preventing any additive present in the tank 4 leaking out in the event of the duct 43 being broken.

The metering pump 5 is integrated in the fuel-drawing module 2. The metering pump 5 is mounted inside said module so as to be removable and so as to enable it to be replaced easily in the event of a breakdown. It is fixed inside the fuel-drawing module by any suitable fixing means, possibly causing it to be suspended resiliently so as to avoid transmitting vibration or other forces from the pump 5 to the drawing module, and vice versa.

The metering pump 5 may be an electric pump, for example, powered in a manner that is not shown in the figures in order to simplify them. It is preferably a positive displacement pump capable of delivering a constant volume of additive on each pump cycle. By way of example, the unit cylinder capacity of the pump may be 8 cubic millimeters (mm³).

The metering pump 5 is controlled by control means 6. These control means are generally constituted by an electronic control unit. They receive information from various sensors, e.g. a sensor indicating that the level in the additive tank is down to a minimum, the fuel gauge in the drawing and gauging module 2, temperature sensors, or a contact for detecting that a hatch for filling the fuel tank 1 has been opened. On the basis of this information, the control means put the pump 5 into operation to deliver a corresponding given volume of additive.

Advantageously, the additive tank 4 is disposed at a higher level than the fuel tank 1 and the metering pump 5. In other words, the additive tank 4 is placed above or substantially above the metering pump 5. This makes it possible to take advantage from an additional column of liquid in the duct 43, 43′ which facilitates priming the pump 5. This also makes it possible to avoid head losses at the outlet from said metering pump.

In a first embodiment of the invention, the outlet 51 of the pump 5 opens out into the reserve bowl 22.

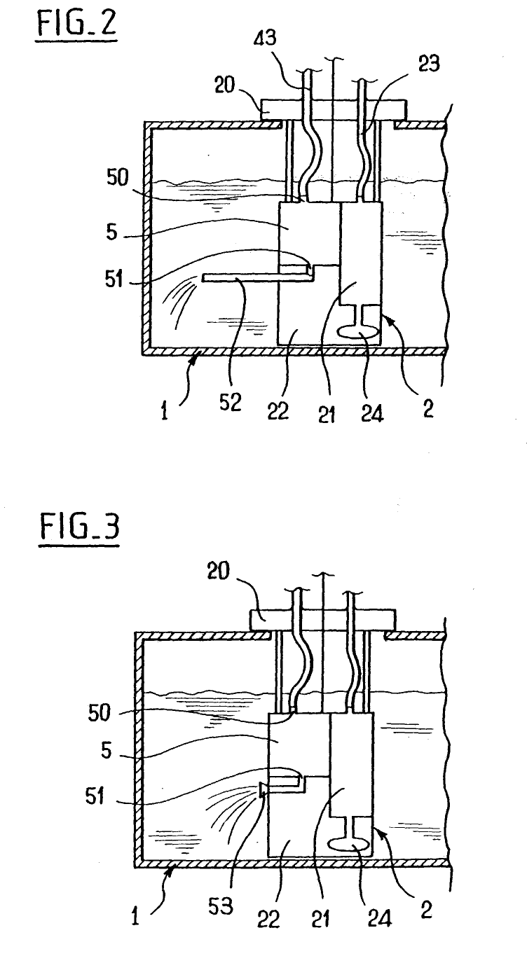

In a second embodiment of the invention as shown in FIGS. 2 and 3, the metering pump 5 delivers the additive directly into the fuel tank 1.

In a first variant of this second embodiment, shown in FIG. 2, the outlet 51 from the metering pump 5 is provided with an offset tube 52 so as to deliver the additive into the fuel tank 1 at a distance sufficient to ensure that it does not flow directly into the reserve bowl 22. This ensures that the additive that has just been delivered is not immediately sucked in and burnt by the engine 3.

In a second variant shown in FIG. 3, the outlet 51 from the metering pump 5 is provided with a nozzle 53 for propelling the additive into the fuel tank 1, thus ensuring as before that it does not flow straight into the reserve bowl 22. By way of example, a nozzle having a diameter of less than 0.5 mm serves to propel the additive about 20 centimeters away form the reserve bowl.

In a third embodiment (not shown in the figures), the outlet 51 from the pump 5 may alternatively be connected to the return duct 25. Such an embodiment is particularly applicable to a tank comprising a plurality of compartments, and the return duct 25 can then serve to introduce additive into a compartment of the tank that is different from the compartment containing the drawing module 2.

Naturally, the present invention is not limited to the particular embodiments described above, but extends to any variant within the spirit of the invention.

In the examples shown in FIGS. 1 to 3, the additive tank 4 is placed outside the fuel tank 1 and above it. In a variant, the additive tank 4 may be placed outside the fuel tank 1, but beside it, or indeed it may be placed inside the fuel tank 1.

What is claimed is:

1/ A system for feeding fuel additive on board a motor vehicle, the system comprising an additive tank and a metering pump suitable for sucking in a controlled quantity of additive from said tank, under the control of control means in order to deliver said quantity into the fuel of said vehicle, wherein said metering pump is integrated in a fuel-drawing module placed inside a fuel tank of the vehicle.

2/ A system according to claim 1, wherein said metering pump is mounted removably inside the drawing module.

3/ A system according to claim 1, wherein said metering pump is mounted inside the drawing module in such a manner as to be suspended therein.

4/ A system according to claim 1, wherein said metering pump delivers the additive to the inside of the reserve bowl of the fuel-drawing module.

5/ A system according to claim 1, wherein said metering pump delivers the additive into a return duct returning excess fuel that is not used by the engine to said fuel tank.

6/ A system according to claim 1, wherein said metering pump delivers the additive directly into the inside of the fuel tank.

7/ A system according to claim 6, wherein the outlet from said metering pump is provided with an offset tube for delivering the additive to the inside of the fuel tank at a distance from said drawing module.

8/ A system according to claim 6, wherein the outlet from said metering pump is provided with a nozzle for propelling the additive inside the fuel tank away from said drawing module.

9/ A system according to claim 1, wherein the additive tank is located above said metering pump.

10/ A system according to claim 1, wherein the outlet orifice from the additive tank is situated in the bottom of said tank and is provided with an anti-leakage valve.

11/ A system according to claim 1, wherein the top portion of said additive tank presents both a filling orifice and an emptying and degassing orifice of diameter greater than 10 mm.
